(19) United States
(12) Patent Application Publication
(10) Pub. No.: US 2016/0301127 A1
(43) Pub. Date: Oct. 13, 2016

(54) MOBILE RADIO DEVICE

(71) Applicant: Asahi Glass Company, Limited, Chiyoda-ku (JP)

(72) Inventors: Ryuta SONODA, Chiyoda-ku (JP); Koji Ikawa, Chiyoda-ku (JP)

(73) Assignee: Asahi Glass Company, Limited, Chiyoda-ku (JP)

(21) Appl. No.: 15/190,356

(22) Filed: Jun. 23, 2016

Related U.S. Application Data
(63) Continuation of application No. PCT/JP2015/051047, filed on Jan. 16, 2015.

(30) Foreign Application Priority Data
Jan. 20, 2014 (JP) 2014-008167

(51) Int. Cl. H01Q 1/24; H01Q 9/42; H01Q 1/40; H01Q 1/48

(52) U.S. Cl. CPC H01Q 1/243; H01Q 1/48; H01Q 9/42; H01Q 1/40

(57) ABSTRACT

A mobile radio device includes a substrate including a ground plane; a casing for accommodating the substrate; and an antenna including a feed element that is connected to a feeding point, the ground plane being a reference of ground for the feeding point, and a radiating element that functions, upon power being fed by establishing electromagnetic field coupling with the feed element, as a radiation conductor, wherein the casing includes a conductor that is electrically and physically connected to the ground plane.

### CROSS-REFERENCE TO RELATED APPLICATION

The present application is a continuation application filed under 35 U.S.C. 111(a) claiming benefit under 35 U.S.C. 120 and 365(c) of PCT International Application No. PCT/JP2015/051047 filed on Jan. 16, 2015 and designating the U.S., which claims priority of Japanese Patent Application No. 2014-008167 filed on Jan. 20, 2014. The entire contents of the foregoing applications are incorporated herein by reference.

### BACKGROUND OF THE INVENTION

1. Field of the Invention

The present invention relates to a mobile radio device.

2. Description of the Related Art

As an antenna to be installed in a mobile radio device, such as a smartphone, a monopole antenna of a contact power feeding type (cf. Patent Document 1 (WO 2013/047033), for example) and a magnetic field coupled type antenna of a contactless power feeding type by using magnetic field coupling (cf. Patent Document 2 (WO 2007/043150), for example) have been known.

For these antennas, however, during installation of a substrate with a ground plane, if a position of the ground plane is shifted from a designed value, a positional relationship with the ground plane is changed, so that impedance matching may not be achieved.

There is a need for a mobile radio device with which impedance matching of an antenna can be easily achieved, even if a positional relationship between the antenna and a ground plane is changed.

### SUMMARY OF THE INVENTION

According to an aspect of the present invention, there is provided a mobile radio device including a substrate including a ground plane; a casing for accommodating the substrate; and an antenna including a feed element that is connected to a feeding point, the ground plane being a reference of ground for the feeding point, and a radiating element that functions, upon power being fed by establishing electromagnetic field coupling with the feed element, as a radiation conductor, wherein the casing includes a conductor that is electrically and physically connected to the ground plane.

According to an embodiment, impedance matching of an antenna can be easily achieved, even if a positional relationship between the antenna and a ground plane is changed.

Other objects, features and advantages of the present invention will become more apparent from the following detailed description when read in conjunction with the accompanying drawings.

### BRIEF DESCRIPTION OF THE DRAWINGS

FIG. 1 is a plan view illustrating an example of an electromagnetic field coupled type antenna of a contactless power feeding type by using electromagnetic field coupling, and a mobile radio device;

FIG. 2 is a diagram illustrating an example of a positional relationship between the electromagnetic field coupled type antenna and each component of the mobile radio device;

FIG. 3 is an enlarged plan view illustrating an example of the electromagnetic field coupled type antenna;

FIG. 4 is an enlarged plan view illustrating an example of a magnetic field coupled type antenna of a contactless power feeding type by using magnetic coupling;

FIG. 5 is an enlarged plan view illustrating an example of a monopole antenna of a contact power feeding type;

FIG. 6 is a diagram illustrating a relationship between an offset amount of a feeding point and a variation amount of S11 of each antenna; and

FIG. 7 is a diagram illustrating a relationship between an offset amount of a substrate and the variation amount of S11 of each antenna.

### DESCRIPTION OF THE PREFERRED EMBODIMENTS

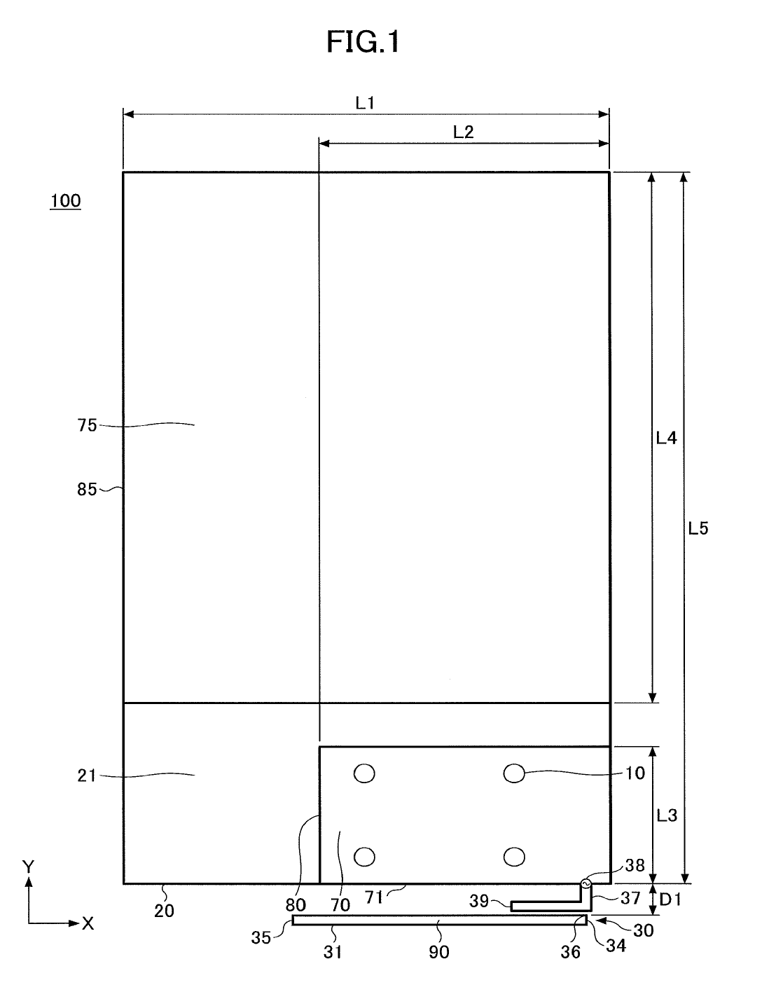

FIG. 1 is a plan view illustrating a computer simulation model for analyzing an operation of an electromagnetic field coupled type antenna 30 (which is referred to as the “antenna 30,” hereinafter), which is installed in a mobile radio device 100. As an electromagnetic field simulator, Microwave Studio (registered trademark) (CST company) was used.

The mobile radio device 100 is a radio communication device, such as a communication terminal that can be carried by a human, for example. As specific examples of the mobile radio device 100, there are electronic devices, such as an information terminal device, a cellular phone, a smartphone, a personal computer, a gaming machine, a television, an audio/video player, and so forth. The mobile radio device 100 includes a substrate 80; a casing 20; and an antenna 30.

The substrate 80 is an example of a substrate with a ground plane 70. The substrate 80 is arranged to be parallel to an XY-plane; and the substrate 80 has a rectangular external shape with a lateral length of L2 that is parallel to the X-axis direction, and a vertical length of L3 that is parallel to the Y-axis direction. A component, such as a capacitor, may be implemented in the substrate 80.

The ground plane 70 is a planar ground pattern; and, in FIG. 1, the rectangular ground plane 70 extending in the XY-plane is exemplified. The ground plane 70 includes an outer edge portion 71 that linearly extends in the X-axis direction. The ground plane 70 is arranged to be parallel to the XY-plane; and the ground plane 70 has a rectangular external shape with a lateral length of L2 that is parallel to the X-axis direction, and a vertical length of L3 that is parallel to the Y-axis direction. The ground plane 70 is laminated on the substrate 80; and the ground plane 70 may be installed on a surface layer (an outer layer) of the substrate 80, or the ground plane 70 may be installed on an inner layer of the substrate 80. The ground plane 70 is a ground part with a ground potential. It is preferable that the ground plane 70 be a ground part with an area that is greater than or equal to a predetermined value, so that impedance matching of the antenna can be easily achieved; however, the ground plane 70 may be a ground part to which components implemented on the substrate 80, such as a capacitor, are electrically connected.

For the case of FIG. 1, the external shapes of the substrate 80 and the ground plane 70 are identical to each other; however the external shapes of the substrate 80 and the ground plane 70 may be different from each other. Further, the substrate 80 and the ground plane 70 are not limited to the depicted shapes.

The casing 20 is an example of a casing for accommodating the substrate 80; and the casing 20 is for fixing a circuit board or a cover glass of the mobile radio device 100, for example. The substrate 80 is fixed to a lid surface, a bottom surface, or a lateral surface of the casing 20, for example. The casing 20 includes a planar conductor 21 that is arranged to be parallel to the XY-plane. The conductor 21 is, for example, a metal part having a rectangular external shape with a lateral length of L1 that is parallel to the X-axis direction, and a vertical length of L5 that is parallel to the Y-axis direction. A part of the casing 20 may be the conductor 21; or the entire casing 20 may be the conductor 21. The conductor 21 may be a component assembled in the casing 20. The casing 20 and the conductor 21 are not limited to the depicted shapes.

The conductor 21 is electrically and physically connected to the ground plane 70. Consequently, the antenna 30 can use, not only the ground plane 70 that is installed in the substrate 80, but also the conductor 21 that is installed in the casing 20, as a ground plane. Since the conductor 21 can be used as the ground plane, the area of the ground plane 70 can be reduced, while maintaining an antenna efficiency (an antenna gain) of the antenna 30. As the area of the ground plane 70 is reduced, the area of the substrate 80 can also be reduced, so that the mobile radio device 100 can be downsized.

Note that the antenna efficiency is a quantity that is calculated as a product of radiation efficiency and a return loss of an antenna; and the antenna efficiency is a quantity that is defined as antenna efficiency with respect to input power.

The area of the conductor 21 is preferably greater than the area of the ground plane 70, so that the conductor 21 can be effectively utilized as a ground plane. However, the area of the conductor 21 may be the same as the area of the ground plane 70; or the area of the conductor 21 may be less than the area of the ground plane.

The conductor 21 is electrically and physically connected to the ground plane 70, for example, through a conductive member (e.g., wire, a metal plate, a conductive adhesive, and so forth). The substrate 80 may be connected to the casing 20 or a member other than the casing 20, so that the conductor 21 and the ground plane 70 are in contact and electrically and physically connected with each other.

The conductor 21 may be electrically and physically connected to the ground plane 70, for example, through a fixing member 10 for fixing the substrate 80 to the casing 20. By electrically and physically connecting the conductor 21 and the ground plane 70 by the fixing member 10, both mechanical connection between the substrate 80 and the casing 20 and electrical connection between the ground plane 70 and the conductor 21 can be achieved by the fixing member 10. In this case, the entire fixing member 10 may have conductivity; or a part of the fixing member 10 may have conductivity. As specific examples of the fixing member 10, there are a metal screw, a conductive adhesive, and so forth.

The numbers and positions of the conductive members and the fixing members 10 for electrically and physically connecting the conductor 21 and the ground plane 70 may be any numbers and any positions. In FIG. 1, an example is illustrated where the conductor 21 and the ground plane 70 are connected by the fixing members 10 at four positions.

The mobile radio device 100 may include a substrate 85, which differs from the substrate 80. The substrate 85 is arranged to be parallel to the XY-plane; and the substrate 85 has a rectangular external shape with a lateral length of L1 that is parallel to the X-axis direction, and a vertical length of L4 that is parallel to the Y-axis direction. A component, such as a capacitor, may be implemented in the substrate 85. The substrate 85 is fixed to the casing 20, for example. The substrate 85 may also be accommodated in the casing 20.

The substrate 85 includes, for example, a ground plane 75. The ground plane 75 is a planar ground pattern arranged to be parallel to the XY-plane; and the ground plane 75 has a rectangular external shape with a lateral length of L1 that is parallel to the X-axis direction, and a vertical length of L4 that is parallel to the Y-axis direction. The ground plane 75 is laminated on the substrate 85; and the ground plane 75 may be installed on a surface layer (an outer layer) of the substrate 85, or the ground plane 75 may be installed on an inner layer of the substrate 85.

For the case of FIG. 1, the external shapes of the substrate 85 and the ground plane 75 are identical to each other; however, the external shapes of the substrate 85 and the ground plane 75 may be different from each other. Further, the substrate 85 and the ground plane 75 are not limited to the depicted shapes.

The antenna 30 is an example of an antenna including a feed element 37, and a radiating element 31.

The feed element 37 is an example of a feed element connected to a feed point 38, for which the ground plane 70 is the reference of the ground. The feed element 37 is a line shaped conductor that can feed power by being contactlessly coupled to the radiating element 31 in a high-frequency manner. In FIG. 1, the feed element 37 is exemplified, which is formed to have an L-shape by a linear conductor that extends in a direction perpendicular to the outer edge portion 71 of the ground plane 70 and parallel to the Y-axis; and by a linear conductor that extends by running in parallel with the outer edge portion 71, which is parallel to the X-axis. For the case of FIG. 1, the feed element 37 extends in the Y-axis direction from the feeding point 38, as a starting point; and then the feed element 37 is bent in the X-axis direction, and extends in the X-axis direction until an end portion 39 of the extension in the X-axis direction. The end portion 39 is an open end to which no other conductor is connected. The feed element 37 is not limited to the depicted shape. Furthermore, in FIG. 1, the feed element 37 is installed in a state in which the feed element 37 is separated from the substrate 80 and is floating in the space. However, for actually installing in the mobile radio device 100, it can be formed in the substrate 80, for example.

The feeding point 38 is a feeding part that is to be connected to a predetermined transmission line or a feeder line that utilizes the ground plane 70. As specific examples of the predetermined transmission line, there are a microstripline, a strip line, a coplanar waveguide with a ground plane (a coplanar waveguide where the ground plane is installed on a surface that is opposite to a conductor surface), and so forth. As the feeder line, there are feeder wire and a coaxial cable. The feed element 37 is connected, for example, to a feeder circuit (e.g., an IC chip with an RF circuit, an IC chip with a baseband circuit, or an integrated circuit, such as a CPU), which is implemented in the substrate 80 or in the substrate 85, through the feeding point 38. The feed element 37 and the feeder circuit may be connected through the above-described different types of transmission lines or feed lines.

Since the feeder circuit can be installed in the substrate 85 that is different from the substrate 80, the feeder circuit can be separated from the ground plane 70 or from the antenna 30, thereby increasing the degrees of freedom of design to define the positional relationship between the feeder circuit and the ground plane 70 or the antenna 30.

The radiating element 31 is a linear radiation conductor part that is arranged along the outer edge portion 71; and the radiating element 31 includes, for example, a conductor part that extends to be parallel to the outer edge portion 71 in the X-axis direction in a state in which the radiating element 31 is separated from the outer edge portion 71 by a predetermined shortest distance in the Y-axis direction. By including the conductor part along the outer edge part 71 in the radiating element 31, directivity of the antenna 30 can be easily controlled, for example. In FIG. 1, the linear radiating element 31 is exemplified; however, the shape of the radiating element 31 may be another shape, such as a L-shape or a loop shape. Further, in FIG. 1, the radiating element 31 is installed in a state in which the radiating element 31 is floating in the space. However, for actually installing it in the mobile radio device 100, it can be formed in a cover glass or in the casing 20 of the mobile radio device 100.

The radiating element 31 and the feed element 37 may be overlapped or may not be overlapped in a plan view in any direction, such as the X-axis direction, the Y-axis direction, or the Z-axis direction, as long as the feed element 37 is separated from the radiating element 31 by a distance with which the feed element 37 can contactlessly feed power to the radiating element 31.

The feed element 37 and the radiating element 31 are arranged to be separated by a distance with which mutual electromagnetic field coupling can be achieved. The radiating element 31 includes a feeding part 36 that is fed power from the feed element 37. The radiating element 31 is contactlessly fed power at the feeding part 36 through the feed element 37 by electromagnetic field coupling. By being fed power in this manner, the radiating element 31 functions as a radiating conductor of the antenna 30.

As illustrated in FIG. 1, if the radiating element 31 is a linear conductor connecting the two points, a resonance current (distribution) similar to that of a half-wavelength dipole antenna is formed on the radiating element 31. Namely, the radiating element 31 functions as a dipole antenna (which is referred to as a “dipole mode,” hereinafter) that resonates at a half-wavelength of a predetermined frequency. Additionally, though it is not depicted, the radiating element 31 may be a loop-shaped conductor such that a rectangular shape is formed by a linear conductor. For a case where the radiating element 31 is a loop-shaped conductor, a resonance current (distribution) similar to that of a loop antenna is formed on the radiating element 31. Namely, the radiating element 31 functions as a loop antenna (which is referred to as a “loop mode,” hereinafter) that resonates at a wavelength of a predetermined frequency.

The electromagnetic field coupling is coupling that utilizes a resonance phenomenon of an electromagnetic field; and the electromagnetic field coupling is disclosed, for example, in a non-patent document (A. Kurs, et al, “Wireless Power Transfer via Strongly Coupled Magnetic Resonances,” Science Express, Vol. 317, No. 5834, pp. 83-86, July 2007). The electromagnetic field coupling is also referred to as electromagnetic field resonant coupling or electromagnetic field resonance coupling; and the electromagnetic field coupling is a technique for transmitting energy, by placing resonators that resonate at the same frequency in close proximity to each other and by causing one of the resonators to be resonated, to the other resonator through coupling in a near field (a non-radiation field area) that is formed between the resonators. Additionally, the electromagnetic field coupling means coupling by an electric field and a magnetic field at a high frequency, excluding capacitive coupling and coupling by electromagnetic induction. Here, “excluding capacitive coupling and coupling by electromagnetic induction” does not mean that all of these couplings disappear, and it implies that these couplings are so small to the extent that no effect is caused. A medium between the feed element 37 and the radiating element 31 may be the air, or a dielectric, such as a glass and a resin. Note that it is preferable not to place a conductive material, such as a ground plane or a display, between the feed element 37 and the radiating element 31.

By establishing the electromagnetic field coupling between the feed element 37 and the radiating element 31, a structure that is robust against impact can be obtained. Namely, by using the electromagnetic field coupling, power can be fed to the radiating element 31 by using the feed element 37 without physical contact between the feed element 37 and the radiating element 31, so that the structure can be obtained that is robust against impact, compared to a contact power feeding method with which physical contact is required.

By establishing the electromagnetic field coupling between the feed element 37 and the radiating element 31, contactless power feeding can be implemented with a simple structure. Namely, by using the electromagnetic field coupling, power can be fed to the radiating element 31 by using the feed element 37 without physical contact between the feed element 37 and the radiating element 31, so that power feeding can be achieved with the simple structure, compared to the contact power feeding method with which physical contact is required. Additionally, by using the electromagnetic field coupling, power can be fed to the radiating element 31 by using the feed element 37 without including an additional component, such as a capacitor plate, so that power feeding can be achieved with the simple structure, compared to a case where power is fed by capacitive coupling.

Furthermore, even if clearance (a coupling distance) between the feed element 37 and the radiating element 31 is increased, an antenna efficiency (an antenna gain) of the radiating element 31 tends not to be lowered for a case where power is fed by electromagnetic field coupling, compared to a case where power is fed by capacitive coupling or by magnetic field coupling. Here, the operational gain is a quantity that is calculated as a product of radiation efficiency and a return loss of an antenna; and the antenna efficiency is a quantity that is defined as radiation efficiency with respect to input power. Thus, by establishing electromagnetic coupling between the feed element 37 and the radiating element 31, degrees of freedom of determining installation positions of the feed element 37 and the radiating element 31 can be increased, whereby positional robustness can be enhanced. Note that high positional robustness means that even if the installation positions of the feed element 37 and the radiating element 31 are shifted, an effect that is caused to the antenna efficiency of the radiating element 31 is small. It is also advantageous in a point that, since the degrees of freedom of determining the installation positions of the feed element 37 and the radiating element 31 are large, a space required for installing the antenna 30 can be easily reduced.

Further, for the case of FIG. 1, the feeding part 36 that is a part at which the feed element 37 feeds power to the radiating element 31 is located at a part other than a center portion 90 between one end portion 34 and the other end portion 35 of the radiating element 31 (the part between the center portion 90 and the end portion 34 or the end portion 35). In this manner, by locating the feeding part 36 at the part of the radiating element 31 other than the part with the lowest impedance at the resonance frequency of a principal mode of the radiating element 31 (the center portion 90 in this case), matching of the antenna 30 can be easily achieved. The feeding part 36 is defined to be the part, which is closest to the feeding point 38, of the conductor part of the radiating element 31 where the radiating element 31 and the feed element 37 are the closest to each other.

For a case of the dipole mode, the impedance of the radiating element 31 increases, as a position separates from the center portion 90 of the radiating element 31 toward the end portion 34 or the end portion 35. For a case of high impedance coupling of the electromagnetic field coupling, even if the impedance between the feed element 37 and the radiating element 31 is slightly changed, an effect caused to the impedance matching is small, as long as the coupling with the impedance that is greater than or equal to a certain level is maintained. Thus, the feeding part 36 of the radiating element 31 is preferably located at a high-impedance portion of the radiating element 31, so that the matching can be easily achieved.

For example, in order to easily achieve impedance matching of the antenna 30, the feeding part 36 can be located at a portion that is separated from the portion with the lowest impedance at the resonance frequency of the principal mode of the radiating element 31 (the center portion 90, in this case) by a distance that is greater than or equal to ⅛ of the entire length of the radiating element 31 (preferably greater than or equal to ⅙; and more preferably greater than or equal to ¼). For the case of FIG. 1, the entire length of the radiating element 31 corresponds to L31 (cf. FIG. 3); and the feeding part 36 is located at the side of the end portion 34 with respect to the center portion 90.

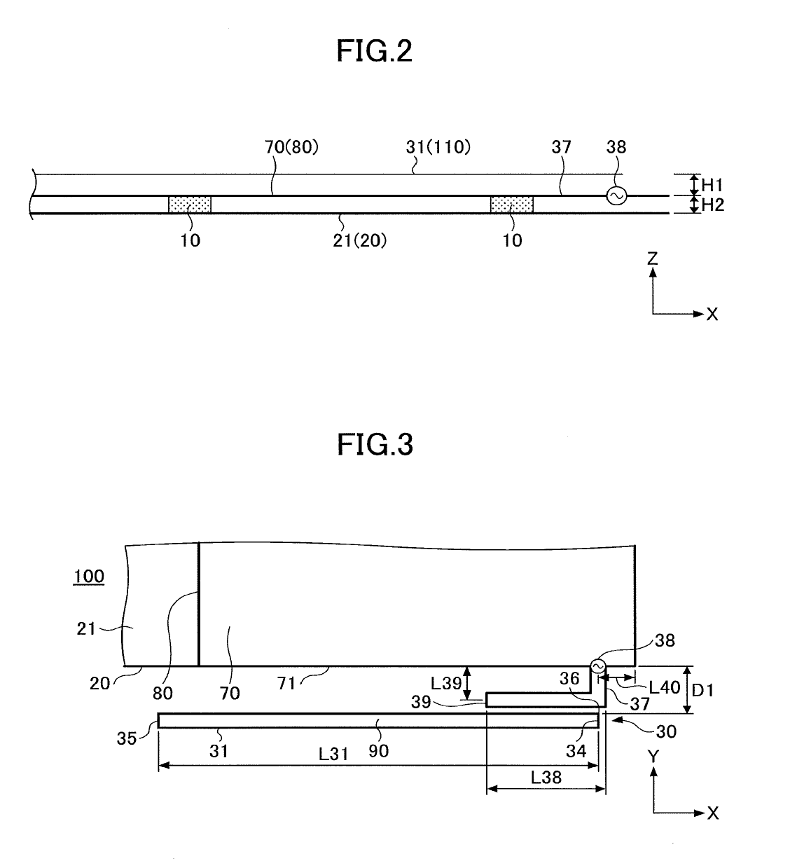

FIG. 2 is a diagram schematically illustrating the positional relationship between the mobile radio device 100 and each component of the antenna 30 in the Z-axis direction. The feed element 37 may be installed on the surface of the substrate 80; or the feed element 37 may be installed at an inner portion of the substrate 80. The radiating element 31 is installed to be separated from the feed element 37; and, for example, as illustrated in FIG. 2, the radiating element 31 is installed in a substrate 110 that faces the substrate 80 while being separated from the substrate 80 by a distance H1. The substrate 80, the substrate 85, or the substrate 110 is, for example, a dielectric substrate formed of a resin; however, a dielectric other than the resin can be used, such as glass, glass ceramics, low temperature co-fired ceramics (LTCC), alumina, and so forth. The radiating element 31 may be installed on the surface of the substrate 110 facing the feed element 37; the radiating element 31 may be installed on the surface of the substrate 110 opposite to the surface facing the feed element 37; or the radiating element 31 may be installed on the lateral side of the substrate 110.

For example, for a case where the antenna 30 is to be installed in a mobile radio device with a display, in FIG. 2, the substrate 110 may be, for example, a cover glass that entirely covers an image display surface of the display; a casing (a margin portion of the casing where the conductor 21 is not formed, in particular, a bottom surface or a lateral surface, etc.) to which the substrate 80 is fixed; or a component included in the mobile radio device (in particular, a chip component or a component formed, for example, by injection molding, e.g., a molded interconnect device (MID), a flexible substrate, a battery, and so forth). The cover glass is a dielectric substrate that is transparent, or semi-transparent to the extent that a user can visually recognize an image displayed on the display; and the cover glass is a flat-plate like member that is laminated and installed on the display.

For a case where the radiating element 31 is installed on the surface of the cover glass, the radiating element 31 may be formed by spreading conductive paste, such as copper and silver, on the surface of the cover glass, and by sintering it. As the conductive paste for this case, conductive paste that can be sintered at a low temperature may be used, which can be sintered at a temperature at which strengthening of the chemically strengthened glass used for the cover glass is not to be weakened. Additionally, to prevent deterioration of the conductor due to oxidation, plating may be applied to it. Furthermore, decorative printing may be made on the cover glass; and the conductor may be formed on the portion where the decorative printing is made. Additionally, for a case where a black shielding film is formed at a periphery of the cover glass, for example, to hide wiring, the radiating element 31 may be formed on the black shielding film.

Furthermore, the positions of the feed element 37, the radiating element 31, and the ground plane 70 in the height direction that is parallel to the Z-axis may be different from each other. Alternatively, all or a part of the positions of the feed element 37, the radiating element 31, and the ground plane 70 in the height direction that is parallel to the Z-axis may be the same.

Additionally, power is fed to a plurality of radiating elements from the single feed element 37. By using the plurality of radiating elements, it can be facilitated to implement multi-band adaptation, wide-band adaptation, directional control, and so forth. Furthermore, a plurality of antennas 30 may be installed in a single mobile radio device.

Furthermore, for a case where a wavelength of a radio wave at the resonance frequency of the principal mode of the radiating element 31 in vacuum is λ₀, the shortest distance D2 (>0) between the feed element 37 and the radiating element 31 is preferably less than or equal to 0.2×λ₀ (more preferably less than or equal to 0.1×λ₀, and further more preferably less than or equal to 0.05×λ₀). It is advantageous to install the feed element 37 and the radiating element 31 to be separated by the shortest distance D2 in a point to enhance the operational gain.

Note that the shortest distance D2 corresponds to the distance of a straight line connecting the closest portions of the feeding part 36 and the feed element 37 for feeding power to the feeding part 36. Further, when the feed element 37 and the radiating element 31 are viewed in any direction, the feed element 37 may or may not intersect the radiating element 31, and the angle of the intersection may be any angle, as long as electromagnetic coupling is established between them. Additionally, the radiating element 31 and the feed element 37 may be on the same plane, or on different planes. Furthermore, the radiating element 31 may be placed on a plane that is parallel to a plane on which the feed element 37 is placed; or the radiating element 31 may be placed on a plane that intersects the plane on which the feed element 37 is placed at any angle.

Additionally, for a case of the dipole mode, a distance with which the feed element 37 and the radiating element 31 are extended in parallel while separated by the shortest distance D2 is preferably less than or equal to ⅜ of the physical length of the radiating element 31. It is more preferably less than or equal to ¼, and further more preferably less than or equal to ⅛. For a case of the loop mode, it is preferably less than or equal to 3/16 of a peripheral length of the inner periphery of the loop of the radiating element 31. It is more preferably less than or equal to ⅛, and further more preferably less than or equal to 1/16.

The position of the shortest distance D2 is the portion where the coupling between the feed element 37 and the radiating element 31 is strong, so that, if the distance with which the feed element 37 and the radiating element 31 are extended in parallel while separated by the shortest distance D2 is long, strong coupling is made at a high impedance portion and a low impedance portion of the radiating element 31, and impedance matching may not be achieved. Thus, it is advantageous, in a point of impedance matching, that the distance with which these are extended in parallel while separated by the shortest distance D2 is short, so that strong coupling is made only at a portion of the radiating element 31 where a variation of the impedance is small.

Furthermore, assuming that an electrical length that induces the principal mode of the resonance of the feed element 37 is Le37, an electrical length that induces the principal mode of the resonance of the radiating element 31 is Le31, the wavelength on the feed element 37 or the radiating element 31 at the resonance frequency f₁ of the principal mode of the radiating element 31 is λ, it is preferable that Le37 be less than or equal to (⅜)·λ; that, for a case where the principal mode of the resonance of the radiating element 31 is the dipole mode, Le31 be greater than or equal to (⅜)·λ and less than or equal to (⅝)·λ; and that, for a case where the principal mode of the resonance of the radiating element 31 is the loop mode, Le31 be greater than or equal to (⅞)·λ and less than or equal to ( 9/8)·λ.

Additionally, since the ground plane 70 is formed in such a manner that an outer edge portion 71 follows the radiating element 31, the feed element 37 can form, by the interaction with the outer edge portion 71, a resonance current (distribution) on the feed element 37 and the ground plane 70, and the feed element 37 resonates with the radiating element 31 to establish the electromagnetic field coupling. Thus, there is no specific lower limit value for the electrical length Le37 of the feed element 37, and the electrical length Le37 may be a length with which the feed element 37 can physically establish electromagnetic field coupling.

Additionally, if it is desirable to add a degree of freedom to the shape of the feed element 37, Le37 is more preferably greater than or equal to (⅛)·λ and less than or equal to (⅜)·λ, and especially preferably greater than or equal to ( 3/16)·λ and less than or equal to ( 5/16)·λ. It is preferable that Le37 be within this range because the feed element 37 favorably resonates at a design frequency (the resonance frequency f₁) of the radiating element 31, and consequently the feed element 37 and the radiating element 31 resonate without depending on the ground plane 70, so that favorable electromagnetic field coupling can be obtained.

Here, the fact that electromagnetic field coupling is established implies that matching is achieved. Further, in this case, it is not necessary to design the electrical length of the feed element 37 to adjust to the resonance frequency f of the radiating element 31, and the feed element 37 can be freely designed as a radiation conductor, so that multi-frequency adaptation of the antenna 30 can be easily achieved. Note that the length of the outer edge portion 71 of the ground plane 70 that follows the radiating element 31, together with the electrical length of the feed element 37, is preferably greater than or equal to (¼)·λ of the design frequency (the resonance frequency f).

Note that, for a case where, for example, a matching circuit is not included, the physical length L37 of the feed element 37 is determined by λ_{g1}=λ₀·k₁, where λ₀ is the wavelength of the radio wave at the resonance frequency of the principal mode of the radiating element in vacuum, and k₁ is a shortening coefficient of a wavelength shortening effect caused by an environment of implementation. Here, k₁ is a value that is calculated from a relative dielectric constant, relative permeability, thickness, a resonance frequency, and so forth of a medium (an environment) of, for example, a dielectric substrate, in which the feed element is installed, such as an effective dielectric constant (∈ᵣ₁) and effective relative permeability (μᵣ₁) of an environment of the feed element 37. Namely, L37 is less than or equal to (⅜)·λ_{g1}. Here, the shortening coefficient may be calculated from the above-described physical properties, or the shortening coefficient may be obtained by actual measurement. For example, a resonance frequency is measured for a target element installed in an environment for which a shortening coefficient is to be measured, and a resonance frequency is measured for the same element in an environment where a shortening coefficient for each frequency is known. Then, the shortening coefficient may be calculated from the difference between these resonance frequencies.

Assuming that a physical length of the feed element 37 is L37 (which corresponds to L39+L38, for the case of FIG. 3), L37 is a physical length providing Le37, and, for an ideal case where no other elements are included, L37 is equal to Le37. For a case where the feed element 37 includes a matching circuit, L37 is preferably greater than zero and less than or equal to Le37. L37 can be shortened (the size is reduced) by using a matching circuit, such as an inductor.

Further, for a case where the principal mode of the resonance of the radiating element 31 is the dipole mode (the radiating element 31 is a linear conductor such that both ends are open ends), Le31 is preferably greater than or equal to (⅜)·λ and less than or equal to (⅝)·λ; more preferably greater than or equal to ( 7/16)·λ and less than or equal to ( 9/16)·λ; and especially preferably greater than or equal to ( 15/32)·λ and less than or equal to ( 17/32)·λ. Additionally, when higher-order modes are considered, Le31 is preferably greater than or equal to (⅜)·λ·m and less than or equal to (⅝)·λ·m; more preferably greater than or equal to ( 7/16)·λ·m and less than or equal to ( 9/16)·λ·m; and especially preferably greater than or equal to ( 15/32)·λ·m and less than or equal to ( 17/32)·λ·m. Note that m is a mode number of the higher-order mode, and it is a natural number. It is preferable that m be an integer from 1 to 5; and it is particularly preferable that m be an integer from 1 to 3. The case where m=1 is the principal mode. It is preferable that L31 be within this range because the radiating element 31 sufficiently functions as a radiation conductor, and the antenna efficiency is favorable.

Similarly, for a case where the principal mode of the resonance of the radiating element 31 is the loop mode (the radiating element 31 is a loop-shaped conductor), Le31 is preferably greater than or equal to (⅞)·λ and less than or equal to ( 9/8)·λ; more preferably greater than or equal to ( 15/16))·λ and less than or equal to ( 17/16)·λ; and especially preferably greater than or equal to ( 31/32))·λ and less than or equal to ( 33/32)·λ. Additionally, for the higher-order modes, Le31 is preferably greater than or equal to (⅞)·λ·m and less than or equal to ( 9/8)·λ·m; more preferably greater than or equal to ( 15/16)·λ·m and less than or equal to ( 17/16)·λ·m; and especially preferably greater than or equal to ( 31/32)·λ·m and less than or equal to ( 33/32)·λ·m. It is preferable that L31 be within this range because the radiating element 31 sufficiently functions as a radiation conductor, and the antenna efficiency is favorable.

Note that the physical length L31 of the radiating element 31 is determined by λ_{g2}=λ₀·k₂, where λ₀ is the wavelength of the radio wave at the resonance frequency of the principal mode of the radiating element in vacuum, and k₂ is a shortening coefficient of a wavelength shortening effect caused by an environment of implementation. Here, k₂ is a value that is calculated from a relative dielectric constant, relative permeability, thickness, a resonance frequency, and so forth of a medium (an environment) of, for example, a dielectric substrate, in which the radiating element is installed, such as an effective dielectric constant (∈ᵣ₂) and effective relative permeability (μᵣ₂) of an environment of the radiating element 31. Namely, for a case where the principal mode of the resonance of the radiating element 31 is the dipole mode, L31 is ideally (½)·λ_{g2}. The length L31 of the radiating element 31 is preferably greater than or equal to (¼)·λ_{g2} and less than or equal to (⅝)·λ_{g2}, and more preferably greater than or equal to (⅜)·λ_{g2}. For a case where the principal mode of the resonance of the radiating element 31 is the loop mode, L31 is greater than or equal to (⅞)·λ_{g2} and less than or equal to ( 9/8)·λ_{g2}.

A physical length L31 of the radiating element 31 is a physical length providing Le31, and, for an ideal case where no other elements are included, L31 is equal to Le31. Even if L31 is shortened by using a matching circuit, such as an inductor, L31 is preferably greater than zero and less than or equal to Le31, and particularly preferably greater than or equal to 0.4×Le31 and less than or equal to 1×Le31. It is advantageous to adjust the length L31 of the radiating element 31 to be such a length in a point to enhance the operational gain of the radiating element 31.

For example, for a case where BT resin (registered trademark) CCL-HL870 (M) (produced by MITSUBISHI GAS CHEMICAL COMPANY, INC.) is used as a dielectric substrate with a relative dielectric constant=3.4, tan δ=0.003, and a substrate thickness of 0.8 mm, the length of L37 is 20 mm, where the design frequency is 3.5 GHz, and the length of L31 is 34 mm, where the design frequency is 2.2 GHz.

Further, for a case where the wavelength of the radio wave at the resonance frequency of the principal mode of the radiating element 31 in vacuum is λ₀, the shortest distance D1 between the feeding part 36 and the ground plane 70 is greater than or equal to 0.0034λ₀ and less than or equal to 0.21λ₀. The shortest distance D1 is more preferably greater than or equal to 0.0043λ₀ and less than or equal to 0.199λ₀, and further more preferably greater than or equal to 0.0069λ₀ and less than or equal to 0.164λ₀. It is advantageous to set the shortest distance D1 to be within such a range in a point to enhance the operational gain of the radiating element 31. Furthermore, since the shortest distance D1 is less than (λ₀/4), the antenna 30 generates a linearly polarized wave, instead of generating a circularly polarized wave.

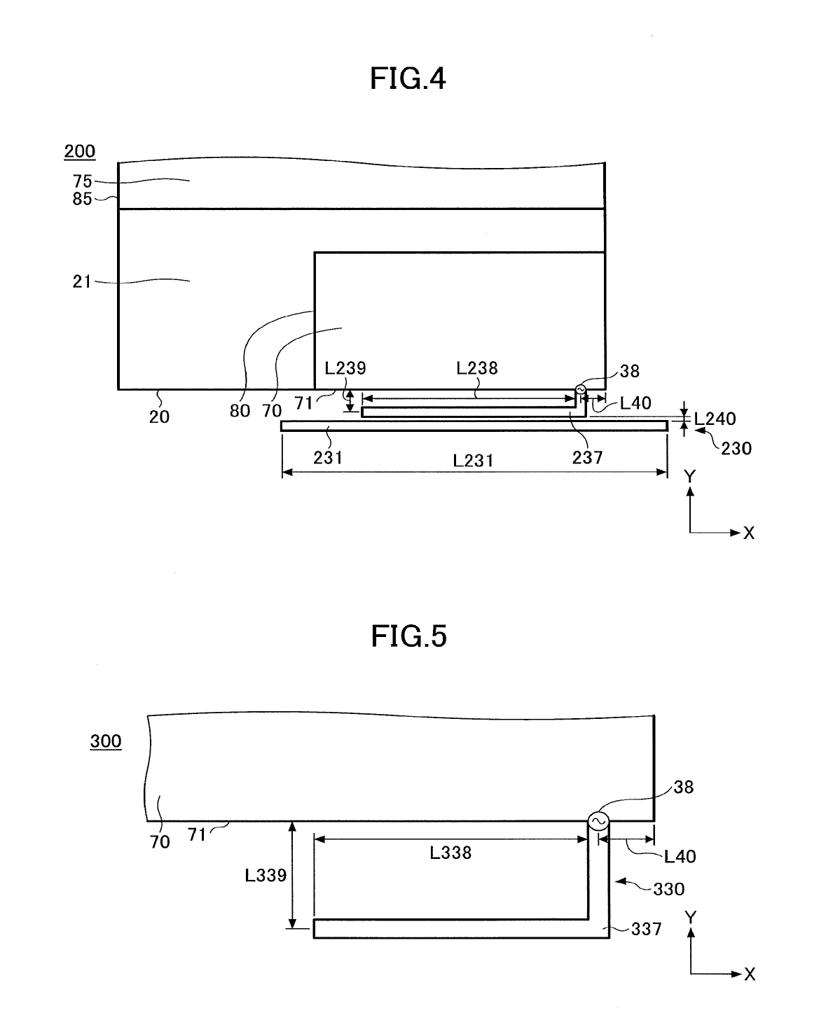

Next, positional robustness of the antenna is described by comparing the antenna 30 (FIG. 3) according to the embodiment of the present invention with another antenna (FIGS. 4 and 5) that is different from that of the embodiment of the present invention.

FIG. 4 is an enlarged plan view illustrating the antenna 230 that is different from that of the embodiment of the present invention. The antenna 230 is a magnetic field coupled antenna of a contactless power feeding type by using magnetic coupling, to which the technique disclosed in the above-described patent document 2 is applied. The mobile radio device 200 to which the antenna 230 is installed has a configuration that is the same as that of the mobile radio device 100 according to the embodiment of the present invention.

The antenna 230 includes a feed element 237, and a passive element 231. The feed element 237 is a linear conductor, for which the ground plane 70 is the reference of the ground, and which is connected to the feeding point 38. The passive element 231 is a linear radiation conductor, to which power is contactlessly fed from the feed element 237 by using magnetic field coupling. The feed element 237 is formed to have the height that is the same as the height of the passive element 231, namely, the feed element 237 is formed on a plane that is the same as the plane on which the passive element 231 is formed.

For the antenna 30 according to the embodiment of the present invention, the type of the coupling between the feed element 37 and the radiating element 31 is the electromagnetic field coupling, so that the feed element 37 and the radiating element 31 are coupled with high impedance. In contrast, for the antenna 230, the type of the coupling between the feed element 237 and the passive element 231 is the magnetic field coupling, so that the feed element 237 and the passive element 231 are coupled with low impedance.

FIG. 5 is an enlarged plan view illustrating an antenna 330 that is different from that of the embodiment of the present invention. The antenna 330 is a monopole antenna of a contact power feeding type. The mobile radio device 300 in which the antenna 330 is installed has a configuration that is the same as the mobile radio device 100 according to the embodiment of the present invention.

The antenna 330 includes a radiating element 337. The radiating element 337 is a linear conductor, for which the ground plane 70 is the reference of the ground, and which is connected to the feeding point 38.

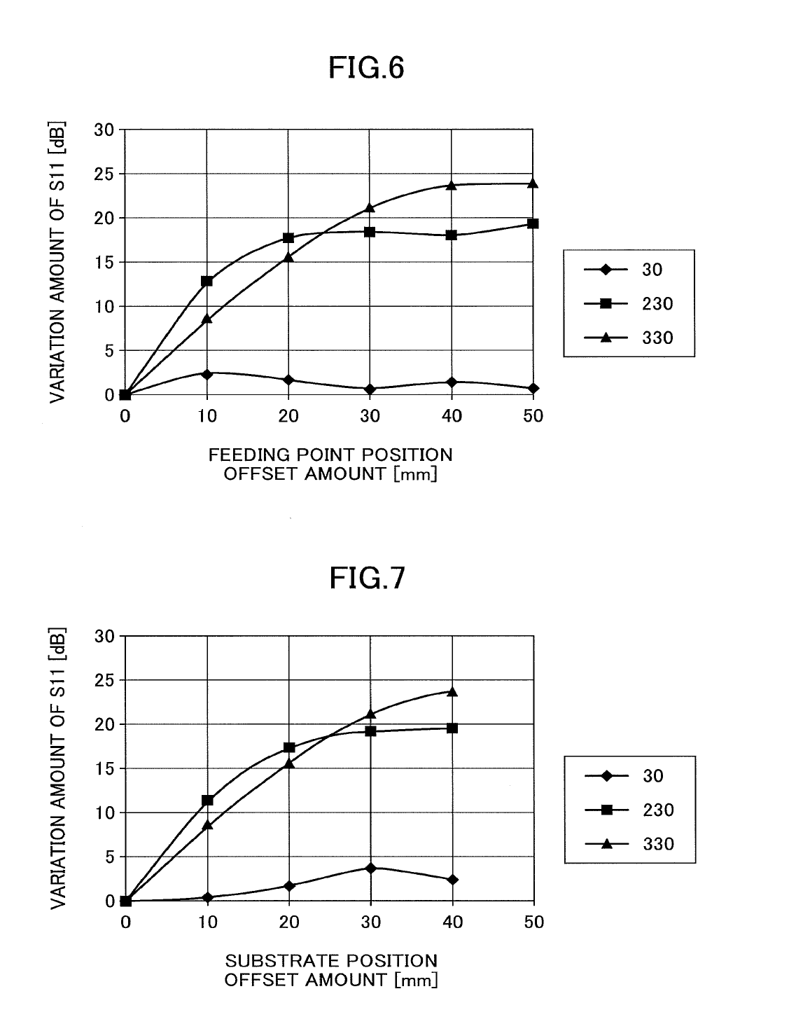

FIG. 6 illustrates, for the antennas 30, 230, and 330 that are designed so that the resonance frequency of the principal mode achieves matching in the vicinity of 2 GHz, variation amounts of S11 (reflection loss) of the antennas 30, 230, and 330, when the position of the feeding point 38 is moved parallel to the X-axis direction.

The “FEEDING POINT POSITION OFFSET AMOUNT” of the horizontal axis represents a distance between a reference position and the feeding point 38 in the X-axis direction; and the reference position is a position of the feeding point 38 (L40=5 mm, for the case of FIG. 6) where the resonance frequency of the principal mode achieves matching in the vicinity of 2 GHz. The offset amount of zero represents a case where the feeding point 38 is at the reference position, and, as the offset amount increases, the feeding point 38 moves toward the left side in the figure. The “VARIATION AMOUNT OF S11” of the vertical axis is a difference between S11 at the matching frequency for a case where the feeding point 38 is at the reference position and S11 at the same frequency for a case where the feeding point 38 is moved. When the feeding point 38 is moved, while the configurations and the sizes of the mobile radio device and the antenna are fixed, only the relative positional relationship between the antenna and the ground plane 70 in the X-axis direction is varied.

The sizes illustrated in FIGS. 1 to 5 at the time of measurement of S11 in units of mm are as follows:
L1: 100,
L2: 60,
L3: 30,
L4: 120,
L5: 160,
H1: 2,
H2: 2,
diameter of the fixing member 10: 4,
L31: 60,
L38: 15,
L39: 5.5,
widths of the radiating element 31 and the feed element 37: 2,
L231: 80,
L238: 45,
L239: 5.5,
L240: 1.0,
widths of the passive element 231 and the feed
element 237: 2,
L338: 45,
L339: 10.5, and
width of the radiating element 337: 2.

Furthermore, the fixing members 10 are cylindrical members, which are provided at four positions; and the fixing members 10 are installed at positions that are offset by 15 mm toward the inner side from the left edge and the right edge of the edge portion of the substrate 80 in the X-axis direction, and that are offset by 5 mm toward inner side from the upper edge and the lower edge in the Y-axis direction, respectively. The diameters are 4 mm.

As illustrated in FIG. 6, even if the offset amount of the feeding point 38 is increased, the variation amount of S11 of the antenna 30 is suppressed to be less than the variation amounts of S11 of the antennas 230 and 330, so that the antenna 30 has high positional robustness against the positional change of the feeding point 38. Thus, for the antenna 30, for example, the design of the position of the feeding point 38 can be relatively freely changed.

FIG. 7 illustrates, for the antennas 30, 230, and 330 that are designed so that the resonance frequency of the principal mode achieves matching in the vicinity of 2 GHz, variation amounts of S11 (reflection loss) of the antennas 30, 230, and 330, when the position of the substrate 80 is moved parallel to the X-axis direction.

The “SUBSTRATE POSITION OFFSET AMOUNT” of the horizontal axis represents a moving distance from a reference position to the substrate 80 in the X-axis direction; and the reference position is a position of the substrate 80 (L40=5 mm, for the case of FIG. 7) where the resonance frequency of the principal mode achieves matching in the vicinity of 2 GHz. The offset amount of zero represents a case where the substrate 80 is at the reference position, and, as the offset amount increases, the substrate 80 moves toward the left side in the figure. The “VARIATION AMOUNT OF S11” of the vertical axis is a difference between S11 at the matching frequency for a case where the feeding point 38 is at the reference position and S11 at the same frequency for a case where the feeding point 38 is moved. When the substrate 80 is moved, while the configurations and the sizes of the mobile radio device and the antenna are fixed, only the relative positional relationship between the substrate 80 and the conductor 21 in the X-axis direction is varied, by moving the antenna and the substrate 80 as a single block.

The sizes illustrated in FIGS. 1 to 5 at the time of the measurement of S11 are the same as the above description.

As illustrated in FIG. 7, even if the offset amount of the substrate 80 is increased, the variation amount of S11 of the antenna 30 is suppressed to be less than the variation amounts of S11 of the antennas 230 and 330, so that the antenna 30 has high positional robustness against the positional change of the substrate 80. Thus, for the case of the antenna 30, even if, for example, the position of the substrate 80 is shifted from the design value during installation of the substrate 80 to the casing 20, impedance matching of the antenna 30 can be easily achieved.

The mobile radio terminal is described above by the embodiment; however, the present invention is not limited to the above-described embodiment. Various modifications and improvements, such as a combination with a part or all of another embodiment or replacement, may be made within the scope of the present invention.

For example, the antenna is not limited to the antenna including the linear conductor portion that extends linearly; and the antenna may include a curved conductor portion. For example, it may include an L-shaped conductor portion; it may include a conductor portion having a meander shape; or it may include a conductor portion that branches in the middle.

Further, a stub may be formed in the feed element, or a matching circuit may be formed in the feed element. In this manner, the area occupied by the feed element in the substrate can be reduced.

What is claimed is:

1. A mobile radio device comprising:
a substrate including a ground plane;
a casing for accommodating the substrate; and
an antenna including a feed element that is connected to a feeding point, the ground plane being a reference of ground for the feeding point, and a radiating element that functions, upon power being fed by establishing electromagnetic field coupling with the feed element, as a radiation conductor,
wherein the casing includes a conductor that is electrically and physically connected to the ground plane.

2. The mobile radio device according to claim 1, wherein the conductor is electrically and physically connected to the ground plane through a fixing member for fixing the substrate to the casing.

3. The mobile radio device according to claim 1, wherein, when an electrical length for inducing a principal mode of a resonance of the feed element is Le37, an electrical length for inducing a principal mode of a resonance of the radiating element is Le31, and a wavelength on the feed element or on the radiating element at a resonance frequency of the principal mode of the radiating element is λ, Le37 is less than or equal to (⅜)·λ, and
wherein, when the principal mode of the resonance of the radiating element is a dipole mode, Le31 is greater than or equal to (⅜)·λ and less than or equal to (⅝)·λ, and when the principal mode of the resonance of the radiating element is a loop mode, Le31 is greater than or equal to (⅞)·λ and less than or equal to ( 9/8)·λ.

4. The mobile radio device according to claim 1, wherein, when a wavelength at a resonance frequency of a principal mode of the radiating element in vacuum is λ₀, a shortest distance between the feed element and the radiating element is less than or equal to 0.2×λ₀.

5. The mobile radio device according to claim 1, wherein the radiating element includes a feeding part for receiving power from the feed element, and
wherein the feeding part is positioned at a portion of the radiating element other than a part with a lowest impedance in a resonance frequency of a principal mode of the radiating element.

6. The mobile radio device according to claim 1, wherein the radiating element includes a feeding part for receiving power from the feed element, and
wherein the feeding part is located at a part that is separated, by a distance that is greater than or equal to ⅛ of an entire length of the radiating element, from a portion of the radiating element with a lowest impedance at a resonance frequency of a principal mode.

7. The mobile radio device according to claim 1, wherein a distance with which the feed element and the radiating element are extended in parallel, while separated by a shortest distance, is less than or equal to ⅜ of a length of the radiating element.

8. The mobile radio device according to claim 1, wherein the radiating element includes a feeding part to which power is fed, upon establishing electromagnetic field coupling with the feed element, and
wherein, when a wavelength at a resonance frequency of a principal mode of the radiating element in vacuum is λ₀, a shortest distance between the feeding part and the ground plane is greater than or equal to 0.034λ₀ and less than or equal to 0.21λ₀.

9. The mobile radio device according to claim 1, further comprising:
a cover glass that entirely covers an image display surface of a display,
wherein the radiating element is installed in the cover glass.

10. The mobile radio device according to claim 1, wherein the radiating element is installed at a margin portion of the casing, wherein the conductor is not formed at the margin portion.

11. The mobile radio device according to claim 1, wherein a feeder circuit is installed on another substrate that is different from the substrate.
